(19) United States
(12) Patent Application Publication
(10) Pub. No.: US 2025/0370527 A1
(43) Pub. Date: Dec. 4, 2025

(54) CENTRALIZED PLATFORM-AGNOSTIC POWER LIMIT MANAGEMENT SYSTEM

(71) Applicant: Microsoft Technology Licensing, LLC, Redmond, WA (US)

(72) Inventors: Aobo GUAN, Redmond, WA (US); Jonathan Bret BARKELEW, Seattle, WA (US); Matthew Branham WEBER, Longmont, CO (US)

(73) Assignee: Microsoft Technology Licensing, LLC, Redmond, WA (US)

(21) Appl. No.: 18/678,365

(22) Filed: May 30, 2024

(51) Int. Cl. G06F 1/3206; G06F 1/3234

(52) U.S. Cl. CPC G06F 1/3206; G06F 1/3234

(57) ABSTRACT

Systems and methods are provided for implementing centralized platform-agnostic power limit management functionalities. A power limit management system includes an input interface, an output interface, and a controller that is part of an operating system of a computing device and that is configured to: receive, via the input interface, (a) power-related data associated with power supplied from a power source device for the computing device; and (b) operational state-related data associated with computing device components. The controller is further configured to: calculate power allocation for a computing device component(s), based on the power-related data and the operational state-related data; and generate a control signal for controlling power consumption for each computing device component, based on the power allocation. For each computing device component, the controller is further configured to send, via the output interface, the control signal to a corresponding actuator to control power consumption by the computing device component.

### BACKGROUND

As the performance of computing devices continues to increase, the control of energy consumption rates in computing device components has become increasingly crucial. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for a centralized platform-agnostic power limit management system. A power limit management system includes an input interface(s), an output interface(s), and a controller(s) that is part of the operating system (or other software modules) and that is configured to: receive, via the input interface, power-related data associated with electrical power supplied from a power source device for the plurality of computing device components; and receive, via the input interface, operational state-related data associated with the plurality of computing device components. The controller is further configured to: calculate power allocation for at least one computing device component among the plurality of computing device components, based on the power-related data and the operational state-related data; and generate a control signal for controlling power consumption for each of the at least one computing device component, based on the power allocation. For each of the at least one computing device component, the controller is further configured to send, via the output interface, the control signal to a corresponding actuator of the at least one actuator for the actuator to control power consumption by the corresponding computing device component.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing centralized platform-agnostic power limit management functionalities.

FIG. 2 depicts an example data flow between the power limit management system of FIG. 1 and each of a power supply device(s) and a computing device component(s) when implementing centralized platform-agnostic power limit management functionalities.

FIG. 3 depicts another example system for implementing centralized platform-agnostic power limit management functionalities.

FIGS. 4A and 4B depict an example method for implementing centralized platform-agnostic power limit management functionalities.

FIG. 5 depict a block diagram illustrating example physical components of a computing device with which aspects of the technology may be practiced.

### DETAILED DESCRIPTION OF CERTAIN EMBODIMENTS

As the performance of computing devices continues to increase, the control of energy consumption rates in computing device components has become increasingly crucial. The primary challenge lies in the growing demand for energy to enhance device performance, juxtaposed with the limited capacity to deliver sufficient power to these components. This limitation is attributed to various factors, such as battery capacity, power adapter size constraints, and/or power adapter thermal constraints. That is, as computing device components become increasingly power hungry, the need for a cross-platform power limit management framework is as prominent as ever. Nowadays, power limit controls are performed by hardware vendors within certain devices they produced, and the interface to control the power limit is dramatically different between vendors. This leads to two major problems. One problem is that the power source is mostly shared by all components on the computer, but such power limit controls are performed at the individual component level, which could lead to sub-optimal control results. For example, if the workload is very central processing unit (“CPU”) dependent, but the graphics processing unit (“GPU”) is using a quite different control strategy that allows it to acquire a greater power budget, the power resource is not given to the CPU, which is the component services workloads use the most. Another problem is that the lack of a standard interface to perform power limit management makes it very complicated to allocate power resource among components, and requires the centralized power controller to deploy diverse interfaces to communicate with devices, which greatly increases project difficulty and cost.

In response to this challenge, in contrast to existing approaches, the present technology provides an operating system-based framework that has been devised to achieve optimal performance while managing limited power resources. This framework includes three major components: input interfaces, a controller(s), and output interfaces. The input interfaces provide information to the operating system to keep it informed about the operational states of computing device components. This information enables the application of control algorithms and the adjustment of device behavior. The controller includes algorithms that respond to device states and offers system designers the ability to configure and fine-tune system behavior. For example, the system can be optimized for performance when connected to an alternating power (“AC”) power source and for efficiency when running on direct current (“DC”) power. The output interfaces transmit control signals to actuators, which can regulate power consumption. For example, these control signals include throttling power usage to stay below a certain wattage, limiting performance to a specific percentage of its maximum capacity, or altering the state of an actuator (e.g., turning off a component).

As part of the operating system, these input and output interfaces are designed to be platform-agnostic. For example, different hardware manufacturers can share the same battery status update interface as an input, and a power limit control interface for a CPU remains consistent for both server and desktop CPUs as an output. In another example, the power limit control interface controls the same type of hardware with different stock keeping units (“SKUs”; which is a unique code including letters and numbers that identify characteristics, such as manufacturer, brand, style, color, size, or other feature), for controlling different hardware components, or hardware components produced by different vendors. For instance, with respect to the latter two cases, the power limit control interface controls a CPU manufactured by vendor A while also controlling a GPU manufactured by vendor B.

Various modifications and additions can be made to the embodiments discussed without departing from the scope of the disclosed techniques. For example, while the embodiments described above refer to a small selection of illustrative features, the scope of the disclosed techniques also includes embodiments having different combinations of features and embodiments that do not include all of the above-described features.

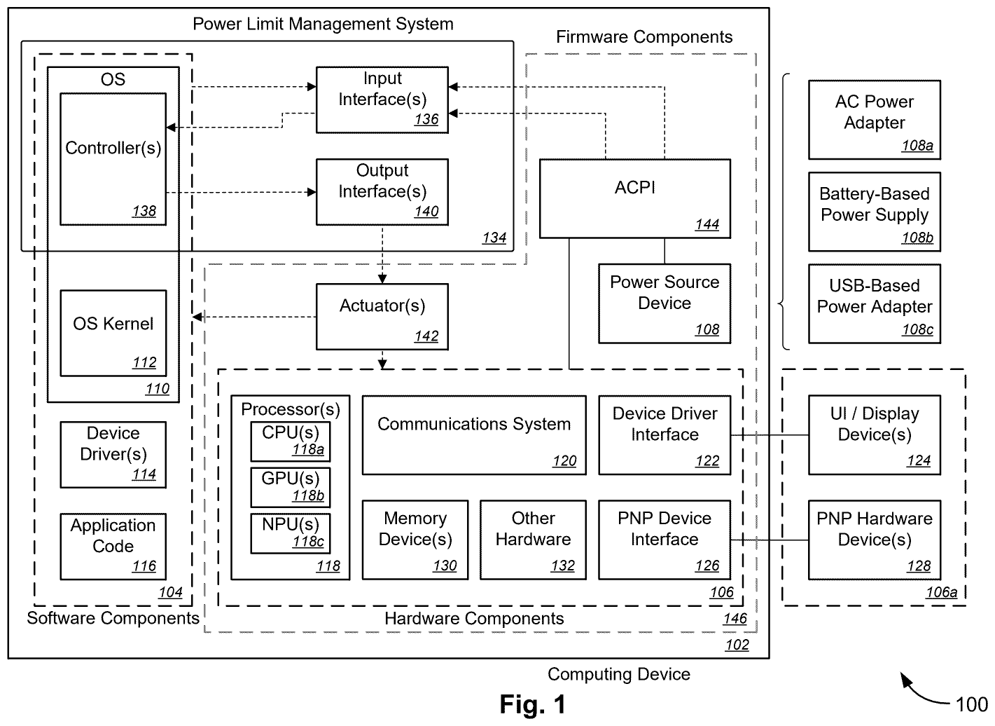

FIGS. 1-5 illustrate some of the features of a method, system, and apparatus for implementing power management functionalities, and, more particularly, to methods, systems, and apparatuses for implementing centralized platform-agnostic power limit management functionalities, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing centralized platform-agnostic power limit management functionalities. System 100 includes computing device 102, which includes software components 104 and hardware components 106 (collectively referred to herein as “computing device components”). System 100 further includes power source device 108, which may be one of an AC power adapter 108a, a battery-based power supply 108b, or a universal serial bus (“USB”)-based power adapter 108c. Some power source devices 108 are integrated within computing device 102, while other power source devices 108 are external to, yet providing power via cables to, computing device 102. Yet other power source devices 108 are partially integrated and partially external to the computing device 102 although connected to the integrated part of the power source device(s). Still other power source devices 108 are battery-based power source devices 108b that are rechargeable via wireless power transfer (e.g., optical, microwave, matched impedance, or inductive wireless power transfer systems). In examples, the computing device 102 is one of a smart phone, a mobile phone, a tablet computer, a desktop computer, a handheld gaming device, a gaming console, or a server, and can be any suitable computing device that has an operating system (“OS”) and multiple computing device components that share a power source.

In some examples, the software components 104 include an OS 110, an OS kernel 112, device drivers 114, and application code 116. The hardware components 106 include a processor(s) 118, including at least one of a CPU(s) 118a, a GPU(s) 118b, and/or a neural processing unit(s) (“NPU(s)”) 118c, or other processor(s). In some examples, the hardware components 106 further include at least one of a communications system 120, an device driver interface (“DDI”) 122, a plug-and-play (“PNP”) device interface 126, a memory device(s) 130, or other hardware component 132. In examples, a user interface or display device(s) 124, which is an external hardware component(s) 106a, connects to computing device 102 via DDI 122. In some examples, a PNP hardware device(s), which is another external hardware component(s) 106a, connects to computing device 102 via PNP device interface 126. In some cases, the user interface or display device(s) 124 includes devices such as keyboards, mice, optical disk drives, printers, scanners, user interface controllers, graphics cards, ports, display screens/monitors, or other devices that each at least partially shares power with the computing device. In some cases, some of these devices are also PNP hardware devices 128; in such cases, either of the DDI 122 or the PNP device interface 126 is used. As shown in FIG. 1, each computing device component among the plurality of computing device components (e.g., software components 104 and/or hardware components 106) is either integrated with the computing device 102 or separate from, yet connected to, the computing device 102.

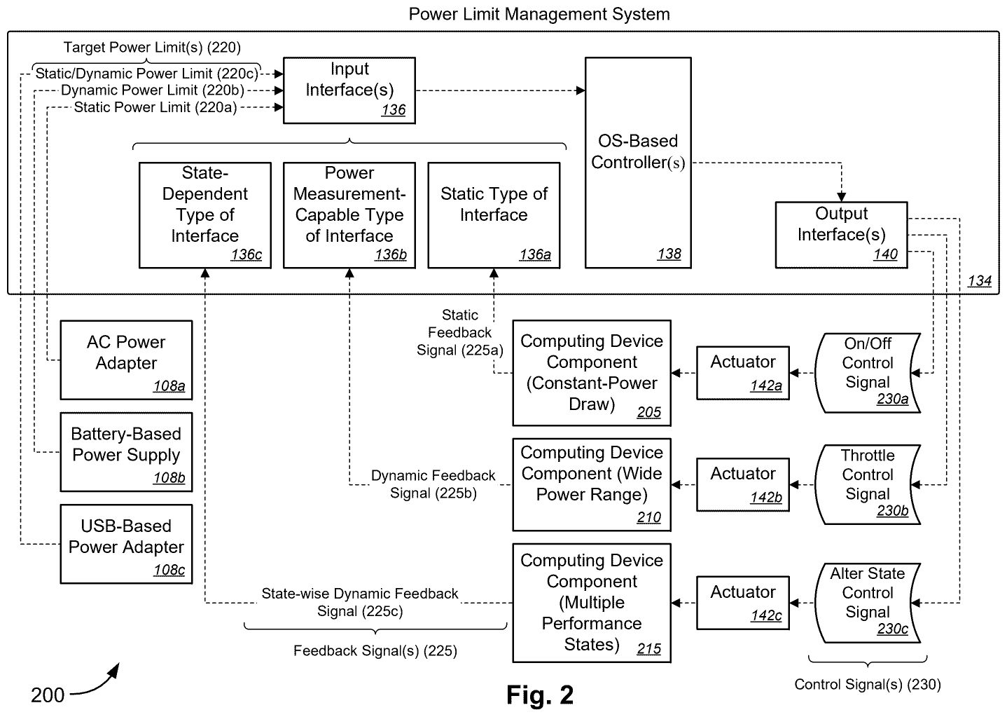

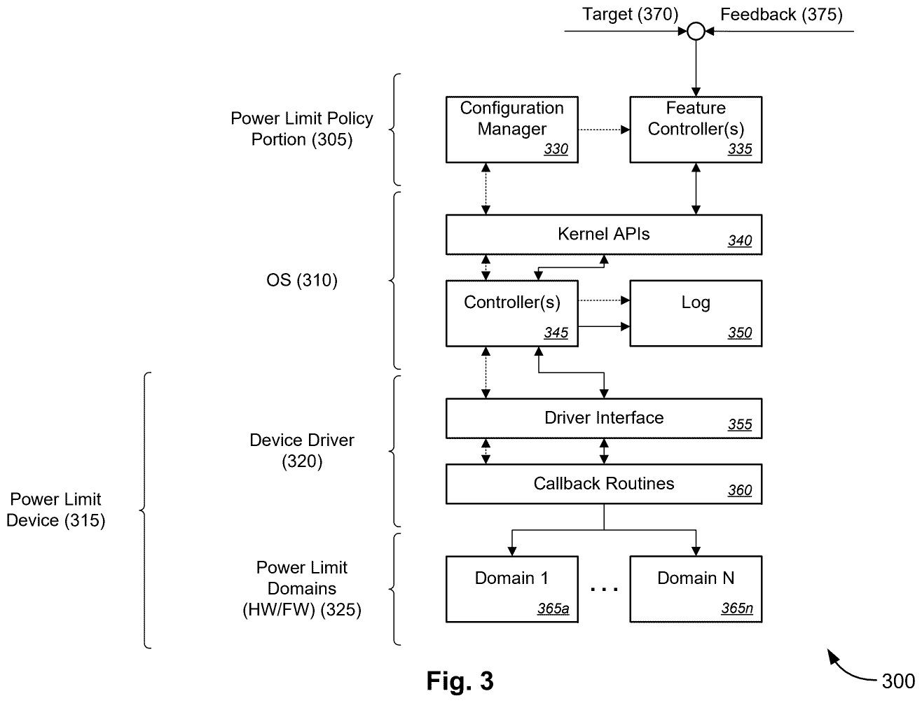

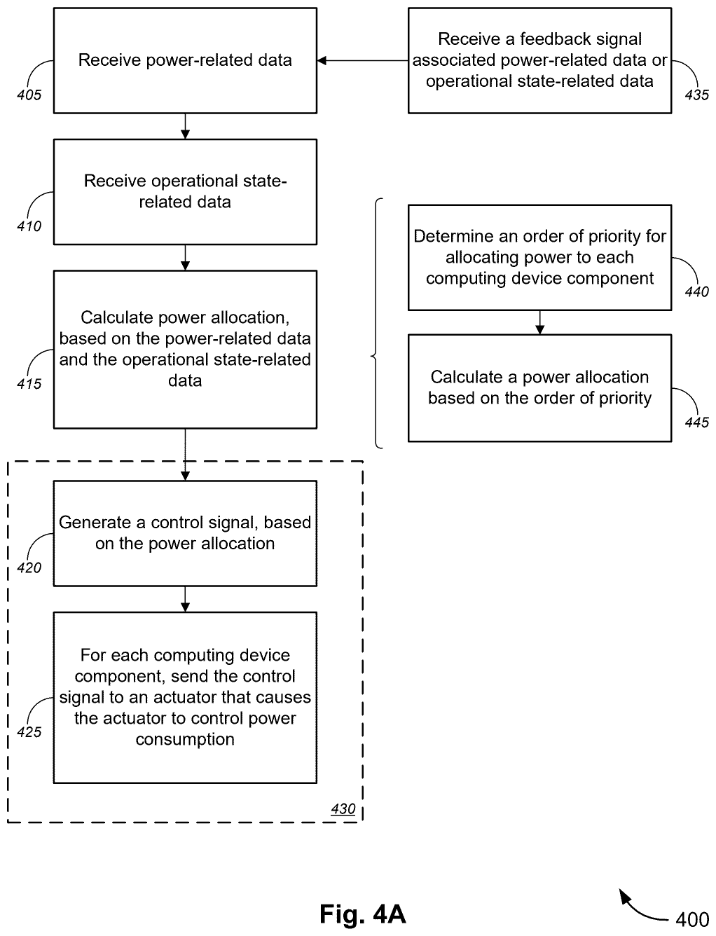

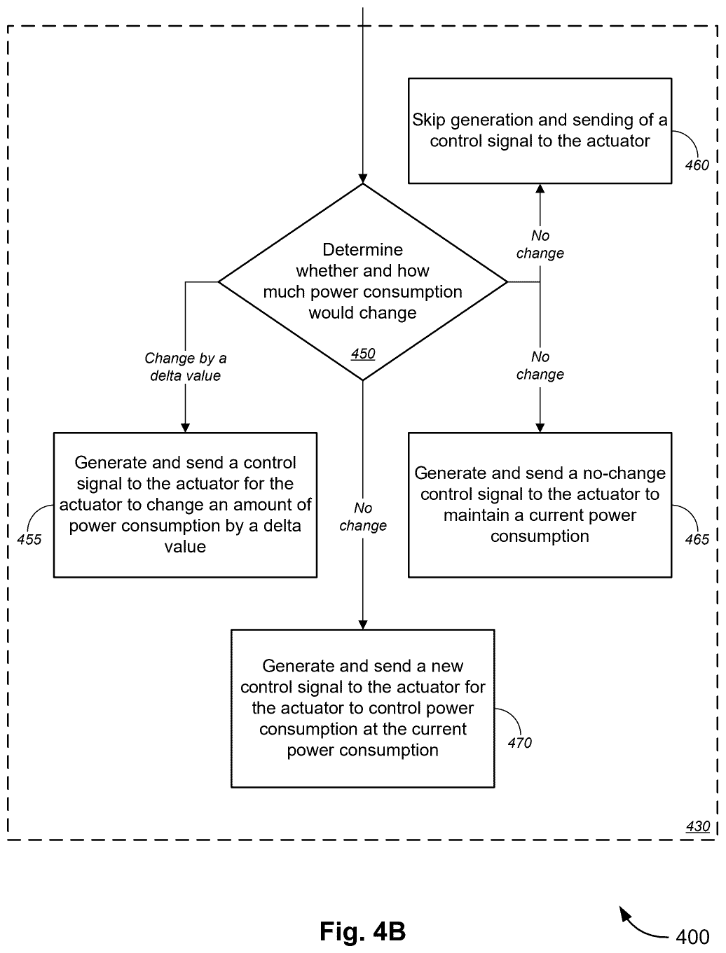

System 100 further includes power limit management system 134, which includes an input interface(s) 136, a controller(s) 138, and an output interface(s) 140. Although not shown, the software components 104 further include software modules operating on the OS 110. In some examples, the controller(s) 138 is part of the OS 110 and/or the other software modules. In some cases, the power limit management system 134 includes multiple input and/or output interfaces 136/140 and multiple controllers 138. In an example, to achieve an overall power consumption target, different controllers for CPU, for GPU, and/or for display device(s) are built that utilize different input algorithms, different output algorithms, and/or different control algorithms. System 100 further includes at least one actuator 142 and an advanced configuration and power interface (“ACPI”) 144. The controller(s) 138, which is part of the OS 110, is configured to receive power-related data (in some cases, a target limit) associated with electrical power supplied from power source device 108 for the plurality of computing device components and/or operational state-related data associated with the plurality of computing device components, via input interface(s) 136 and via one or more of ACPI 144, DDI 122, and/or PNP device interface 126. This is shown in FIG. 1 by the solid lines from hardware components 106 and power source device 108 to ACPI 144, by dash-lined arrows from ACPI 144 and/or software components 104 to input interface(s) 136 and from input interface(s) 136 to controller(s) 138. In some instances, system 100 includes firmware components 146, which includes hardware components 106, power source device 108, AC power adapter 108a, battery-based power supply 108b, USB-based power adapter 108c, actuator(s) 142, and ACPI 144. In some cases, power-related data is (alternatively or further) accessible via an internal lookup within the OS 110 (which may query memory device(s) 130) or an external database query (in some cases, via communications system 120 to external databases via wired and/or wireless network connections). The controller(s) 138 is further configured to calculate power allocation for the computing device components, based on the power-related data and the operational state-related data, and to generate a control signal for controlling power consumption for each computing device component based on the power allocation. The controller(s) 138 is further configured to send the control signal to the actuator(s) 142 via output interface(s) 140, with the actuator(s) 142 in turn being configured to control or regulate power consumption for each computing device component based on the control signal. This is shown in FIG. 1 by dash-lined arrows from controller(s) 138 to output interface(s) 140, from output interface(s) 140 to actuator(s) 142, and from actuator(s) 142 to each of software components 104 and hardware components 106. The functionalities of the power limit management system 134 is described in detail below with respect to FIGS. 2-4B. For example, data flow 200 as described below with respect to FIG. 2 covers the data and signals that are input via input interface(s) 136 and output via output interface(s) 140. FIG. 3, as described below, covers another example system 300 in which an OS-based controller is used to implement centralized platform-agnostic power limit management functionalities. Data flow 200 as described below with respect to FIG. 2, example system 300 as described below with respect to FIG. 3, and example method 400 as described below with respect to FIGS. 4A and 4B may be applied with respect to the operations of system 100 of FIG. 1.

FIG. 2 depicts an example data flow 200 between the power limit management system of FIG. 1 and each of a power supply device(s) and a computing device component(s) when implementing centralized platform-agnostic power limit management functionalities. As shown in FIG. 2, OS-based controller(s) 138 of power limit management system 134 is configured to receive, via the input interface(s) 136, a target power limit 220 associated with the power-related data associated with electrical power supplied from the power source device 108 (e.g., one of an AC power adapter 108a, a battery-based power supply 108b, or a USB-based power adapter 108c (e.g., a USB-C power adapter or power delivery device)). In an example, the target power limit 220 includes a static target value or static power limit 220a associated with a power source device having a constant-power output or a fixed power profile (e.g., AC power adapter 108a). In another example, the target power limit 220 includes a dynamic target value or dynamic power limit 220b associated with a power source device having a variable-power output or a dynamic power profile (e.g., battery-based power supply 108b). In yet another example, the target power limit 220 includes a static/dynamic target value or a static/dynamic power limit 220c associated with a power source device either having a constant-power output or a fixed power profile (e.g., a USB adapter under power device standard 1.0) or having a variable-power output or a dynamic power profile (e.g., a USB adapter under power device standard 2.0 or higher). In examples, the target power limit 220 includes power-related data including one of: (a) static power-related data associated with sustained power, peak power, power capacity, or power usage state for one or more static states of the power source device 108; or (b) runtime power-related data associated with sustained power, peak power, power capacity, or power usage state for one or more runtime states of operation of the power source device 108. In some examples, runtime and static power information can be supplied by power source devices, and are used to determine the total power that can be consumed by the whole system.

The OS-based controller(s) 138 is further configured to receive, via the input interface(s) 136, a feedback signal 225 associated with at least one of power-related data or operational state-related data for a computing device component(s) 205-215. In an example, the feedback signal includes one of a static feedback signal 225a associated with a computing device component 205 having a constant-power draw, a dynamic feedback signal 225b associated with a computing device component 210 having a wide power range (or having power control capability), or a state-wise dynamic feedback signal 225c associated with a computing device component 215 having multiple performance states with different power draw levels. In examples, the feedback signal 225 includes power-related data including one of: (c) estimated power-related data associated with one or more of estimated total power consumption by the plurality of computing device components or estimated power consumption by each of the plurality of computing device components; or (d) actual power-related data associated with one or more of actual total power consumption by the plurality of computing device components or actual power consumption by each of the plurality of computing device components. In some examples, actual or estimated power consumption of a device describes how fast the energy is consumed by components of the system. Due to the variance of power consumption components and their capability of measuring actual power, the input interface(s) 136 includes three types of interfaces.

The three types of interfaces of the input interface(s) 136 include a static type of interface 136a, a power measurement-capable type of interface 136b, and a state-dependent type of interface 136c. The static type of interface 136a is configured for use with, and to receive a static feedback signal 225a from, the computing device component 205 having the constant-power draw (e.g., a camera whose power is relatively stable, where as long as it has been turned on, the power is almost a constant number). The power measurement-capable type of interface 136b is configured for use with, and to receive a dynamic feedback signal 225b from, the computing device component 210 having the wide power range (e.g., CPUs or GPUs). In examples, the power measurement-capable type of interface 136b includes power measurement modules that are configured to report an actual power consumption of the computing device component 210. In some examples, the dynamic feedback signal 225b is received or accessible via one of a DDI, an ACPI, or a PNP device interface. The state-dependent type of interface 136c is configured for use with, and to receive a state-wise dynamic feedback signal 225c from, the computing device component having multiple performance states with different power draw levels and lacking a capability or need to measure its power consumption. In some cases, the multiple performance states are separated as different runtime states, where each performance state has an associated power consumption rate. Such devices can report its state-power static configuration to the OS-based controller(s) 138 or the OS during boot up, and can update its runtime state to the OS-based controller(s) 138 or the OS. A monitor display is a typical example of such an interface. In some examples, the power draw level for one or more of the multiple performance states for the computing device component is accessible via one of an internal lookup within the OS, an external database query, a DDI, an ACPI, or a PNP device interface.

In examples, the input interface(s) 136 is configured to support poll-based updates and event-driven updates for each of the power-related data and the operational state-related data. For example, the controller(s) 138 can poll the power source device 108 through the input interface(s) 136 periodically, or program certain events to be interrupted by the power source device (e.g., to notify the controller(s) 138 or the OS at a switch between AC power and DC power, or to notify that the sustained power has changed +/−5% since the last update).

For each of the computing device components 205, 210, and 215, the OS-based controller(s) 138 receives, via input interface(s) 136, one of static power limit 220a from AC power adapter 108a, dynamic power limit 220b from battery-based power supply 108b, or static/dynamic power limit 220c from USB-based power adapter 108c. The OS-based controller(s) 138 further receives at least one of:
(1) static feedback signal 225a from the computing device component 205, via the static type of interface 136a of the input interface(s) 136;
(2) dynamic feedback signal 225b from the computing device component 210, via the power measurement-capable type of interface 136b; and/or
(3) state-wise dynamic feedback signal 225c from the computing device component 215, via the state-dependent type of interface 136c.

Based on the received target power limit(s) 220 and the feedback signal(s) 225, the OS-based controller(s) 138 calculates power allocation for each computing device component 205, 210, or 215, generates a control signal 230, and sends the control signal 230 to an actuator 142 via output interface(s) 140. For computing device component 205, the OS-based controller(s) 138 calculates power allocation for computing device component 205, generates an on/off control signal 230a, and sends the on/off control signal 230a to an actuator 142a via output interface(s) 140. The actuator 142a turns on or turns off power to the computing device component 205 based on the control signal 230a, which is based on at least one of the target power limit(s) 220 and the feedback signal(s) 225.

For computing device component 210, the OS-based controller(s) 138 calculates power allocation for computing device component 210, generates a throttle control signal 230b, and sends the throttle control signal 230b to an actuator 142b via output interface(s) 140. The actuator 142b throttles power to the computing device 210 based on the control signal 230b, which is based on at least one of the target power limit(s) 220 and the feedback signal(s) 225. In examples, the throttle control signal 230b includes one of a control signal to throttle power usage to remain below a set wattage value; or a control signal to limit performance to a set percentage of a maximum capacity of the computing device component.

For computing device component 215, the OS-based controller(s) 138 calculates power allocation for computing device component 215, generates an alter state control signal 230c, and sends the alter state control signal 230c to an actuator 142c via output interface(s) 140. The actuator 142c turns on or turns off power to the computing device component 215 based on the control signal 230c, which is based on at least one of the target power limit(s) 220 and the feedback signal(s) 225. In examples, the alter state control signal 230c includes a control signal to alter a performance state of the corresponding actuator for the computing device component having multiple performance states with different power draw levels.

In aspects, the OS-based controller(s) 138 or the OS employs control strategies to calculate the control to each system component (e.g., computing device component) to limit their power consumption based on system inputs (e.g., total power budget and actual power consumption of each computing device component) and to control strategy parameters that are specified by a system designer. The controller(s) 138 offers methods to configure individual control strategies for system components, in some cases, using configuration knobs. The configuration knobs include specifying the target and feedback of each individual control loop, the sampling method for inputs (e.g., poll-based inputs or event driven inputs), the parameter of the control loop, and/or which device is the actuator for the control loop output. For example, where control of power consumption of the CPU is desired, the target power limit is specified to be 50% of the total power budget of the system (herein referred to as a “Target”), the actual sustained power is consumed by the CPU as feedback (herein referred to as a “Feedback”), and the target and feedback is sampled every 5 seconds (herein referred to as “Sampling Rate”). The system uses a proportional-integral-derivative (“PID”) algorithm as the control algorithm and tunes the proportional, integral, and derivative coefficients Kₚ, Kᵢ, and Kₐ, respectively, to values of 100, 20, 10, respectively (collectively, “Control Algorithm and Parameters”), and sends the calculated result to the CPU to control its sustained power consumption rate (herein referred to as “Output”).

In addition to in-box basic control algorithms (e.g., PID, adder, subtracter, abstraction function, multiplier, and/or divider algorithms), the framework of the power limit management system also defines PNP driver interfaces to allow customization of control algorithms, and to allow selected modules to send control signals to the OS. The framework enables tracing or following of such control signals to designated output modules. In some cases, if a system designer would like to protect their control algorithms and a data flow, software binaries are built through this framework. Those software binaries perform desired computing, but other entities cannot reverse engineer those binaries to check the logic inside. That is, the control signal includes control algorithms and a data flow that are encoded as software binaries that are built via a PNP device interface by a system designer associated with the computing device, wherein the software binaries are configured to control power consumption of the computing device while preventing access to the control algorithms and the data flow that are encoded in the software binaries by third parties.

In some aspects, output interfaces 140 are used for transmitting control signals to designated devices to ensure that the total power consumption of the system is less than or equal to the maximum power that power sources can supply or to achieve better user experience with a limited power resource. There are three types of information that are supplied by output interfaces. For devices that have power controlling capability (e.g., computing device component 210), the OS-based controller(s) 138 or the OS defines platform-agnostic standards for receiving the power limit target through such interfaces, and the device throttles its performance to limit its power consumption under the given target. Typical devices include CPUs and GPUs, which can keep their frequency under certain levels to apply the power limitation. For devices that do not have fine power controlling capability but can enter a lower power or performance state (e.g., computing device component 215), the OS-based controller(s) 138 or the OS can send signals to change the state of such devices to reduce the total power consumption of the system. For example, when the power budget is limited, the OS can disable the USB-C charging capability, which blocks charging of devices like phones through the USB port. A gradient state control example is a display monitor whose power usage can be reduced by dimming the screen of the monitor display.

Different from an actuator that reduces power consumption directly, the output interface enables improving the user experience even when the power resource is tight. The OS-based controller(s) 138 or the OS supplies policy settings to allow allocation of the limited power resource to threads that are interacting with a user directly. For example, when a power limit is applied to the CPU, the system throughput will be reduced. The OS-based controller(s) 138 or the OS can prioritize graphical user interface (“GUI”) threads to make the user experience less sluggish, while deprioritizing background threads (e.g., software updates) that are less noticeable by the user.

With the modules and interfaces described above, this framework offers a platform-agnostic power management solution capable of handling software and hardware state changes, thereby allowing for flexible power control in computing devices. Compared with the existing approaches where power control is predominantly handled by hardware vendors, the OS-based solution described herein offers the following three distinct advantages: (i) platform-agnostic interfaces; (ii) comprehensive device coverage; and (iii) influencing OS behavior for application payloads. Platform-agnostic interfaces are designed to be platform-agnostic, a feature lacking in current solutions that are tailored to specific devices of hardware vendors. This distinction is advantageous because existing approaches often provide controllers with only partial insights, limiting their ability to manage a full spectrum of devices. For instance, a power mitigation framework offered by a CPU vendor solely focuses on monitoring the CPU's power consumption without any knowledge of a GPU's power dynamics. Consequently, the control measures are confined to the CPU, since such a framework remains oblivious to the GPU's states and control capabilities. Comprehensive device coverage has the capacity to encompass all devices within the system, by ensuring that the operating system possesses awareness of the states of all the devices. Conversely, the existing approaches are typically tailored to a limited set of devices produced by a single hardware vendor. Influencing OS behavior for application payloads, one of whose distinguishing features is its ability to impact the behavior of the operating system in the context of servicing application payloads, is absent in the existing approaches, which lack the flexibility to exert control over OS behavior in this specific area.

In the manner as described above, power allocation to and/or power limits for the computing device component(s) 205, 210, and/or 215 is controlled or regulated, using the OS-based controller(s) 138, thereby enabling agnostic power limit management, control, and/or regulation. As used herein, “control” refers to general control of the power usage or power limits for the computing device components 205, 210, and/or 215, while “regulate” refers to controlling or maintaining the rate or speed of change of the power being used or the power limits being set for the computing device components 205, 210, and/or 215.

FIG. 3 depicts another example system 300 for implementing centralized platform-agnostic power limit management functionalities. Turning to FIG. 3, system 300 includes a power limit policy portion 305, OS 310 (e.g., OS 110 of FIG. 1), and a power limit device 315 (also referred to herein as “output interface”), which includes device driver portion 320 (e.g., device driver(s) 114, DDI 122, and/or PNP device interface 126 of FIG. 1) and power limit domains 325 (including for hardware components 106 and for software components 104 of FIG. 1). The power limit policy portion 305 includes configuration manager 330 and feature controller(s) 335. The OS 310 includes kernel application programming interfaces (“APIs”) 340, controller 345, and log 350. The device driver portion 320 includes driver interface 355 and callback routines 360. The power limit domains 325 includes a plurality of domains 1 through N 365a-365n. As shown in FIG. 3, solid line arrows correspond to control data based on target 370 and/or feedback 375, while dotted line arrows correspond to configuration data. The control data (as denoted by the solid line arrows) and the configuration data (as denoted by the dotted line arrows) each flows through feature controller(s) 335, kernel APIs 340, controller 345, log 350, driver interface 355, and callback routines 360. The control data (as denoted by the solid line arrows) further flows to each of the plurality of domains 365a-365n. The configuration data (as denoted by the dotted line arrows) further flows through configuration manager 330 back to feature controller(s) 335.

Referring to FIG. 3, a target signal (370) (e.g., target power limits 220 and 220a-220c of FIG. 2) and/or a feedback signal (375) (e.g., feedback signals 225 and 225a-225c of FIG. 2) are/is received by a controller 345 via feature controller(s) 335 and kernel APIs 340. The controller 345 receives configuration data from configuration manager 330 via kernel APIs 340. In examples, the controller 345 logs, in log 350, at least one of the target signal (370), the feedback signal (375), and/or configuration data from the configuration manager 330. In some examples, the controller 345 exchanges configuration data with callback routines 360 via driver interface 355 and configuration manager 330 via kernel APIs 340. In examples, the controller 345 also exchanges control data with callback routines 360 via driver interface 355 and feature controller 335 via kernel APIs 340. The control data is used by the callback routines to control or regulate power allocation or power limits with the plurality of domains 365a-365n, in a manner as described above with respect to FIGS. 1 and 2.

The framework of FIG. 3, particularly the power limit device 315 (or the output interface), is configured to handle complicated actuators (e.g., a System on a Chip (“SoC”), which is a type of processor that integrates multiple modules like CPU, GPU, and/or NPU modules). Such actuators include multiple components that could control their power limits individually. For example, the actuators allow controller 345 to set power limits for CPUs, GPUs, and/or NPUs separately. In some examples, there is only one driver for such devices, namely, a DDI (e.g., DDI 122 of FIG. 1). In the output interface, “domain” refers to module(s) whose power can be controlled together. With this “domain” concept, the controller can send individual power limit targets to each domain 365 through only a single DDI. In examples, the OS 310 can also supply hints to such devices or domains 365a-365n to balance power budget between modules within it, such as described below with respect to sending of power control signals, programming upper and lower thresholds, and/or supply power consumption bias information to the controller 345.

In some aspects, to solve the two problems discussed above, an aspect of the present technology provides a centralized power limit management system that includes three major parts: (1) a controller; (2) the OS; and (3) a power limit device. The control device is a software module that allocates the power budget among devices based on information supplied to it. The OS functions as a hub to collect power-related information (e.g., AC/DC, maximum power that can be supplied by power sources, and power demand of current workload) and to transfer power limit decisions made by the controller to actuators (e.g., power limit device 315). The power limit device is a hardware component that is capable of controlling its power consumption rate under a given target through performance throttling (e.g., CPU can lower its frequency to reduce power). The controller is produced by a vendor, or other counterparts, of the OS, original equipment manufacturer (“OEM”) device, or hardware, and the power limit devices are mostly produced by the hardware vendor. The OS defines three standard interfaces to achieve seamless communication among modules produced by different vendors: (A) a control interface; (B) a feedback interface, and (C) a workload characterization interface. The control interface, which is responsible for tracing or following a controller's control signals to a designated power limit device, includes a set of OS APIs that can be called by the controller to set power targets for each individual device. In some cases, a standard device driver interfaces with the control interface to allow the OS to detect and communicate with power limit devices to send power control signals. The feedback interface, which is responsible for sending the actual power consumption conditions to the controller to make decisions, is an interface that supports polling to check value updates periodically. It also allows the controller to program upper and lower thresholds to the power limit device through the OS, and the power limit device notifies upper software layers when thresholds are crossed. The workload characterization interface, which is part of the OS that skims recent executed workload, characterizes their power consumption bias. For example, if those workloads are AI dominated, the demand for NPUs and GPUs will be greater than for CPUs, and the OS will supply such information to the controller through this interface to help the controller allocate more power budget for the NPUs/GPUs.

FIGS. 4A and 4B depict an example method 400 for implementing centralized platform-agnostic power limit management functionalities. FIG. 4B depicts an example set of implementations for the generation and sending processes 430 as shown in FIG. 4A. The operations of method 400 are performed by a controller of a power limit management system (e.g., controller(s) 138 of power limit management system 134 of FIGS. 1 and 2), and the controller is part of an OS of a computing device (e.g., OS 110 of computing device 102 of FIG. 1).

With reference to FIG. 4A, method 400, at operation 405, includes receiving, via an input interface (e.g., input interface(s) 136 of FIGS. 1 and 2), power-related data associated with electrical power supplied from a power source device (e.g., power source devices 108 and 108a-108c of FIGS. 1 and 2) for the plurality of computing device components (e.g., software components 104, hardware components 106, and computing device components 205-215 of FIGS. 1 and 2). In examples, the power-related data for a computing device component is received in response to a query based on a component identification information or component related data for the computing device (e.g., SKU, model number, or other identifying data for the computing device). In some examples, as described above with respect to FIGS. 1 and 2, each computing device component is either integrated with the computing device or separate from, yet connected to, the computing device. At operation 410, method 400 includes receiving, via the input interface, operational state-related data associated with the plurality of computing device components.

In examples, the power-related data includes at least one of:
(a) static power-related data associated with sustained power, peak power, power capacity, or power usage state for one or more static states of the power source device;
(b) runtime power-related data associated with sustained power, peak power, power capacity, or power usage state for one or more runtime states of operation of the power source device;
(c) estimated power-related data associated with one or more of estimated total power consumption by the plurality of computing device components or estimated power consumption by each of the plurality of computing device components; or
(d) actual power-related data associated with one or more of actual total power consumption by the plurality of computing device components or actual power consumption by each of the plurality of computing device components.

Method 400 further includes, at operation 415, calculating power allocation for at least one computing device component among the plurality of computing device components, based on the power-related data and the operational state-related data. In examples, calculating power allocation for the at least one computing device component (at operation 415) includes calculating power allocation for each of the plurality of computing device components to configure and fine-tune overall power consumption behavior of the computing device. For example, the computing device can be optimized for performance when connected to AC power source and for efficiency when running on DC power. In some examples, calculating the power allocation (at operation 415) includes determining an order of priority for allocating power to each of the plurality of computing device components (at operation 440); and calculating a power allocation for the at least one computing device component based on the order of priority (at operation 445). In examples, the order of priority is based on attributes of a software workload that is under execution to allocate power budget among devices (e.g., more power to a CPU if workloads are CPU-dependent).

Method 400 further includes generating a control signal for controlling power consumption for each of the at least one computing device component, based on the power allocation (at operation 420). In some examples, the control signal for each of the at least one computing device component includes one of:
(1) a control signal to throttle power usage to remain below a set wattage value for a computing device component having a wide power range or having power control capability;
(2) a control signal to limit performance to a set percentage of a maximum capacity of another computing device component having a wide power range or having power control capability; or
(3) a control signal to alter a performance state of the corresponding actuator for a computing device component having multiple performance states with different power draw levels.

For each of the at least one computing device component, method 400, at operation 425, includes sending, via an output interface, the control signal to a corresponding actuator of at least one actuator for the actuator to control power consumption by the corresponding computing device component. In examples, each of the at least one actuator is configured to control power consumption by a corresponding one of the at least one computing device component. In some examples, the generating and sending processes (collectively, “generating and sending processes 430” or “processes 430”) includes various sub-processes as described in detail below with respect to FIG. 4B.

At operation 435, method 400 includes receiving, via the input interface, a feedback signal associated with at least one of power-related data or operational state-related data for the at least one computing device component, with example feedback signals being shown and described above with respect to FIG. 2. The processes at operations 405-430 are repeated further based on the feedback signal (from operation 435).

Referring to FIG. 4B, generating and sending processes 430, in some examples, includes determining whether and how much power consumption would change for each of the at least one computing device component based on the power allocation (at operation 450). Based on a determination that the power consumption would change by a delta value, generating and sending processes 430 includes generating and sending a control signal to a corresponding actuator for the actuator to change an amount of power consumption by the corresponding computing device component by the delta value (at operation 455). However, based on a determination that the power consumption would not change, generating and sending processes 430 includes performing one of several operations 460-470. In an example, generating and sending processes 430 includes skipping generation and sending of a control signal to the corresponding actuator for the corresponding computing device component (at operation 460). In another example, generating and sending processes 430 includes generating and sending a no-change control signal to the corresponding actuator for the actuator to maintain a current power consumption by the corresponding computing device component (at operation 465). In yet another example, generating and sending processes 430 includes generating and sending a new control signal to the corresponding actuator for the actuator to control power consumption by the corresponding computing device component, the new control signal corresponding to the current power consumption by the corresponding computing device component (at operation 470).

While the techniques and procedures in method 400 are depicted and/or described in a certain order for purposes of illustration, it should be appreciated that certain procedures may be reordered and/or omitted within the scope of various embodiments. Moreover, while the method 400 may be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 (e.g., by executing instructions embodied on a computer readable medium), the systems, examples, or embodiments 100, 200, and 300 of FIGS. 1, 2, and 3 can each also operate according to other modes of operation and/or perform other suitable procedures.

As should be appreciated from the foregoing, the present technology provides multiple technical benefits and solutions to technical problems. For instance, one technical problem arises with existing approaches, which are driver-based and which are vendor-specific, where such existing approaches are typically incompatible with computing device components that are associated with other vendors. Accordingly, existing approaches, particularly where computing device components are associated with multiple different or separate vendors, are not capable of achieving optimized power performance for the entire computing device or the entire set of computing device components of the computing device. The present technology provides a centralized platform-agnostic power limit management system. A power limit management system includes an input interface(s), an output interface(s), and a controller(s) that are part of the operating system and that is configured to: receive, via the input interface, power-related data associated with electrical power supplied from a power source device for the plurality of computing device components; and receive, via the input interface, operational state-related data associated with the plurality of computing device components. The controller is further configured to: calculate power allocation for at least one computing device component among the plurality of computing device components, based on the power-related data and the operational state-related data; and generate a control signal for controlling power consumption for each of the at least one computing device component, based on the power allocation. For each of the at least one computing device component, the controller is further configured to send, via the output interface, the control signal to a corresponding actuator of the at least one actuator for the actuator to control power consumption by the corresponding computing device component. With the modules and interfaces described above, a centralized system is built, with system-level awareness and platform-agnostic power limit control system.

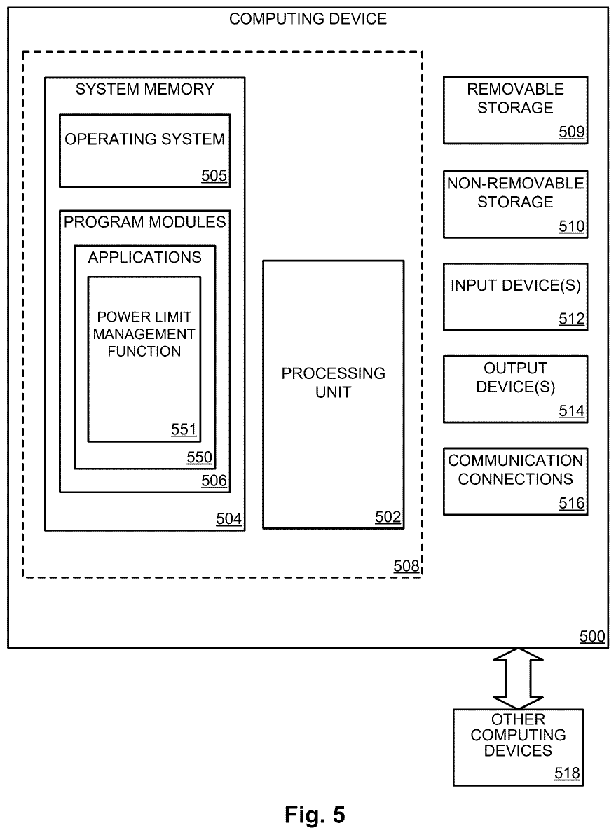

FIG. 5 depicts a block diagram illustrating physical components (i.e., hardware) of a computing device 500 with which examples of the present disclosure are practiced. The computing device components described below are suitable for a client device implementing the centralized platform-agnostic power limit management functionalities, as discussed above. In a basic configuration, the computing device 500 includes at least one processing unit 502 and a system memory 504. The processing unit(s) (e.g., processors) are referred to as a processing system. Depending on the configuration and type of computing device, the system memory 504 includes volatile storage (e.g., random access memory), non-volatile storage (e.g., read-only memory), flash memory, or any combination of such memories. The system memory 504 includes an operating system 505 and one or more program modules 506 suitable for running software applications 550, such as a power limit management function 551, to implement one or more of the systems or methods described above.

The operating system 505, for example, is suitable for controlling the operation of the computing device 500. Furthermore, aspects of the invention are practiced in conjunction with a graphics library, other operating systems, or any other application program and is not limited to any particular application or system. This basic configuration is illustrated in FIG. 5 by those components within a dashed line 508. The computing device 500 has additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files are stored in the system memory 504. While executing on the processing unit 502, the program modules 506 perform processes including one or more of the operations of the method(s) as illustrated in FIGS. 4A and 4B, or one or more operations of the system(s) and/or apparatus(es) as described with respect to FIGS. 1-3, or the like. Other program modules used in accordance with examples of the present disclosure include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure is practiced via a system-on-a-chip (“SOC”) where each or many of the components illustrated in FIG. 5 may be integrated onto a single integrated circuit. Such an SOC device includes one or more processing units, graphics units, communications units, system virtualization units and various application functionalities all of which are integrated (or “burned”) onto the chip substrate as a single integrated circuit. When operating via an SOC, the functionality, described herein, with respect to generating suggested queries, is operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500, in examples, also has one or more input devices 512 such as a keyboard, a mouse, a pen, a sound input device, and/or a touch input device, etc. The output device(s) 514 such as a display, speakers, and/or a printer, etc. is also included, in some examples. The aforementioned devices are examples and others may be used. In examples, the computing device 500 includes one or more communication connections 516 allowing communications with other computing devices 518. Examples of suitable communication connections 516 include radio frequency (“RF”) transmitter, receiver, and/or transceiver circuitry; universal serial bus (“USB”), parallel, and/or serial ports; and/or the like.

The term “computer readable media” as used herein includes computer storage media. Computer storage media includes volatile and nonvolatile, and/or removable and non-removable, media that, in some examples, is implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media, in some examples, is embodied by computer readable instructions, data structures, program modules, or other data in a modulated data signal, such as a carrier wave or other transport mechanism, and includes any information delivery media. In examples, the term “modulated data signal” describes a signal that has one or more characteristics that are set or changed in such a manner as to encode information in the signal. By way of example, communication media includes wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A computing device, comprising:
an operating system (“OS”);
an actuator, configured to control power consumption by each of a plurality of computing device components, each computing device component integrated or connected with the computing device; and
a power limit management system, comprising:
an input interface;
an output interface; and
a controller, configured within the operating system, configured to:
receive, via the input interface, power-related data associated with electrical power supplied from a power source device for the plurality of computing device components;
receive, via the input interface, operational state-related data associated with the plurality of computing device components;
calculate a power allocation for each of the plurality of computing device components, based on the power-related data and the operational state-related data;
generate a control signal for controlling power consumption for each of the plurality of computing device components, based on the power allocation; and
for each of the plurality of computing device components, send, via the output interface, the control signal to the actuator, the control signal causing the actuator to control power consumption by the corresponding computing device component.

2. The computing device of claim 1, wherein the computing device is one of a smart phone, a mobile phone, a tablet computer, a desktop computer, a handheld gaming device, a gaming console, or a server, wherein the plurality of computing device components includes software components and hardware components, the software components including the OS, a kernel, device drivers, and application code, and the hardware components including at least one of a central processing unit (“CPU”), a graphics processing unit (“GPU”), a neural processing unit (“NPU”), other processors, a memory device, an interface device, a communications system, or a plug-and-play (“PNP”) hardware device, wherein the power source device is one of an alternating current (“AC”) power adapter, a battery-based power supply, or a universal serial bus (“USB”)-based power adapter.

3. The computing device of claim 1, wherein the power-related data includes at least one of:
static power-related data associated with sustained power, peak power, power capacity, or power usage state for one or more static states of the power source device;
runtime power-related data associated with sustained power, peak power, power capacity, or power usage state for one or more runtime states of operation of the power source device;
estimated power-related data associated with one or more of estimated total power consumption by the plurality of computing device components or estimated power consumption by each of the plurality of computing device components; or
actual power-related data associated with one or more of actual total power consumption by the plurality of computing device components or actual power consumption by each of the plurality of computing device components.

4. The computing device of claim 1, wherein the controller is further configured to:
receive, via the input interface, a target power limit associated with the power-related data associated with electrical power supplied from the power source device, wherein the target power limit includes one of a static target value associated with a power source device having a constant-power output or a dynamic target value associated with a power source device having a variable-power output; and
receive, via the input interface, a feedback signal associated with at least one of power-related data or operational state-related data for the at least one computing device component, wherein the feedback signal includes one of a static feedback signal associated with a computing device component having a constant-power draw or a dynamic feedback signal associated with either a computing device component having a wide power range or a computing device component having multiple performance states with different power draw levels;
wherein the power allocation for the computing device component is further based on at least one of the target power limit and the feedback signal.

5. The computing device of claim 4, wherein the input interface includes:
a static type of interface that is configured for use with the computing device component having the constant-power draw;
a power measurement-capable type of interface that is configured for use with the computing device component having the wide power range, and that includes power measurement modules that are configured to report an actual power consumption of the computing device component; and
a state-dependent type of interface that is configured for use with the computing device component having multiple performance states with different power draw levels and lacking a capability or need to measure its power consumption.

6. The computing device of claim 5, wherein the power draw level for one or more of the multiple performance states for the computing device component is accessible via one of an internal lookup within the OS, an external database query, a device driver interface (“DDI”), an advanced configuration and power interface (“ACPI”), or a plug-and-play (“PNP”) device interface.

7. The computing device of claim 1, wherein the input interface is configured to support poll-based updates and event-driven updates for each of the power-related data and the operational state-related data.

8. The computing device of claim 1, wherein the power-related data for a computing device component is received in response to a query based on a component identification information or component related data for the computing device.

9. The computing device of claim 1, wherein calculating power allocation for the at least one computing device component comprises:
determining an order of priority for allocating power to each of the plurality of computing device components; and
calculating a power allocation for the at least one computing device component based on the order of priority.

10. The computing device of claim 1, wherein the control signal for each of the at least one computing device component includes one of:
a control signal to throttle power usage to remain below a set wattage value for a computing device component having a wide power range or having power control capability;
a control signal to limit performance to a set percentage of a maximum capacity of another computing device component having a wide power range or having power control capability; or
a control signal to alter a performance state of the corresponding actuator for a computing device component having multiple performance states with different power draw levels.

11. The computing device of claim 1, wherein generating and sending the control signal comprises, for each of the plurality of computing device components:
quantifying power consumption change for the computing device component based on the power allocation; and
performing one of:
based on a quantification of the power consumption changing by a delta value, generating and sending a control signal to a corresponding actuator for the actuator to change an amount of power consumption by the corresponding computing device component by the delta value; or
based on a quantification of the power consumption not changing, performing one of:
skipping generation and sending of a control signal to the corresponding actuator for the corresponding computing device component;
generating and sending a no-change control signal to the corresponding actuator for the actuator to maintain a current power consumption by the corresponding computing device component; or
generating and sending a new control signal to the corresponding actuator for the actuator to control power consumption by the corresponding computing device component, the new control signal corresponding to the current power consumption by the corresponding computing device component.

12. A computer-implemented method, comprising:
receiving, by a controller of a power limit management system conducted by an operating system (“OS”) of a computing device and via an input interface, power-related data associated with electrical power supplied from a power source device for a plurality of computing device components, each computing device component being integrated or connected to the computing device;
receiving, via the input interface, operational state-related data associated with the plurality of computing device components;
calculating power allocation for at least one computing device component among the plurality of computing device components, based on the power-related data and the operational state-related data;
quantifying power consumption change for each of the at least one computing device component based on the power allocation; and
performing one of:
based on a quantification of the power consumption changing by a delta value, generating and sending a control signal to a corresponding actuator for the actuator to change an amount of power consumption by the corresponding computing device component by the delta value; or based on a quantification of the power consumption not changing, performing one of:
skipping generation and sending of a control signal to the corresponding actuator for the corresponding computing device component;
generating and sending a no-change control signal to the corresponding actuator for the actuator to maintain a current power consumption by the corresponding computing device component; or
generating and sending a new control signal to the corresponding actuator for the actuator to control power consumption by the corresponding computing device component, the new control signal corresponding to the current power consumption by the corresponding computing device component.

13. The computer-implemented method of claim 12, wherein the power-related data includes at least one of:
static power-related data associated with sustained power, peak power, power capacity, or power usage state for one or more static states of the power source device;
runtime power-related data associated with sustained power, peak power, power capacity, or power usage state for one or more runtime states of operation of the power source device;
estimated power-related data associated with one or more of estimated total power consumption by the plurality of computing device components or estimated power consumption by each of the plurality of computing device components; or
actual power-related data associated with one or more of actual total power consumption by the plurality of computing device components or actual power consumption by each of the plurality of computing device components.

14. The computer-implemented method of claim 13, wherein the at least one computing device component, wherein the input interface includes a power measurement-capable type of interface that is configured for use with the computing device component, and that includes power measurement modules that are configured to report the actual power consumption of the computing device component, wherein the method further comprises:
receiving, via the power measurement-capable type of interface, a feedback signal associated with at least one of power-related data or operational state-related data for the computing device component, wherein the feedback signal includes a dynamic feedback signal associated with the computing device component;
wherein the control signal for the computing device component includes one of:
a control signal to limit performance to a set percentage of a maximum capacity of the computing device component.

15. The computer-implemented method of claim 14, wherein the dynamic feedback signal is received or accessible via one of a device driver interface (“DDI”), an advanced configuration and power interface (“ACPI”), or a plug-and-play (“PNP”) device interface.

16. The computer-implemented method of claim 13, wherein the at least one computing device component includes a computing device component having multiple performance states with different power draw levels, wherein the input interface includes a state-dependent type of interface that is configured for use with the computing device component having multiple performance states with different power draw levels and lacking a capability or need to measure its power consumption, wherein the method further comprises:
receiving, via the state-dependent type of interface, a feedback signal associated with at least one of power-related data or operational state-related data for the computing device component, wherein the feedback signal includes a dynamic feedback signal associated with the computing device component having the multiple performance states with different power draw levels;
wherein the control signal for the computing device component includes a control signal to alter a performance state of the corresponding actuator for the computing device component having multiple performance states with different power draw levels.

17. The computer-implemented method of claim 13, wherein the control signal includes control algorithms and a data flow that are encoded as software binaries that are built via a PNP device interface by a system designer associated with the computing device, wherein the software binaries are configured to control power consumption of the computing device while preventing access to the control algorithms and the data flow that are encoded in the software binaries by third parties.

18. A power limit management system, comprising:
an actuator, configured to regulate power consumption by each of a plurality of computing device components, each computing device component being integrated or connected with a computing device;
an input interface;
an output interface; and
a controller, executed from an operating system (“OS”) of the computing device, configured to:
receive, via the input interface, power-related data associated with electrical power supplied from a power source device for the plurality of computing device components;
receive, via the input interface, operational state-related data associated with the plurality of computing device components;
calculate power allocation for each of the plurality of computing device components, based on the power-related data and the operational state-related data;
generate a control signal for regulating power consumption for each of the plurality of computing device components, based on the power allocation; and
for each of the plurality of computing device components, send, via the output interface, the control signal to an actuator that causes the actuator to regulate power consumption by the corresponding computing device component.

19. The power limit management system of claim 18, wherein the controller is further configured to:
receive, via the input interface, a target power limit associated with the power-related data associated with electrical power supplied from the power source device, wherein the target power limit includes one of a static target value associated with a power source device having a constant-power output or a dynamic target value associated with a power source device having a variable-power output; and
receive, via the input interface, a feedback signal associated with at least one of power-related data or operational state-related data for the at least one computing device component, wherein the feedback signal includes one of a static feedback signal associated with a computing device component having a constant-power draw or a dynamic feedback signal associated with either a computing device component having a wide power range or a computing device component having multiple performance states with different power draw levels;
wherein the power allocation for the computing device component is further based on at least one of the target power limit and the feedback signal.

20. The power limit management system of claim 19, wherein the input interface includes:
a static type of interface that is configured for use with the computing device component having the constant-power draw;
a power measurement-capable type of interface that is configured for use with the computing device component having the wide power range, and that includes power measurement modules that are configured to report an actual power consumption of the computing device component; and
a state-dependent type of interface that is configured for use with the computing device component having multiple performance states with different power draw levels and lacking a capability or need to measure its power consumption.
